(19) United States
(12) Patent Application Publication
(10) Pub. No.: US 2002/0065973 A1
(43) Pub. Date: May 30, 2002

(54) Method and a apparatus for transmitting data on a can data link

(76) Inventor: Brian K. Holfelner, Chillicothe, IL (US)

Correspondence Address: CATERPILLAR INC., 100 N.E. ADAMS STREET, PATENT DEPT., PEORIA, IL, 616296490

(21) Appl. No.: 09/727,278

(22) Filed: Nov. 30, 2000

(51) Int. Cl. G06F 13/00

(52) U.S. Cl. 710/310

(57) ABSTRACT

Apparatuses and methods for transmitting data. A data link transmits a plurality of signals, one signal at a time. A plurality of electronic devices is coupled with the data link, and transmit respective first signals to the data link. The plurality of electronic devices also receive a second signal and attempt to transmit the respective first signal onto the data link as a function of receiving the second signal. A signal generating device is coupled with the data link and transmits a third signal to the plurality of electronic devices via the data link for a predetermined period of time. The transmission of the third signal occurs after the second signal is transmitted to the plurality of electronic devices and prior to the transmission of the plurality of first signals from the plurality of electronic devices in response to the second signal.

### TECHNICAL FIELD

This invention relates generally to prioritizing the transmission of data on a data link, and more specifically to the arbitration of data for transmission on a CAN data link.

### BACKGROUND

Controller Area Network data links and their protocol (“CAN data link” or “CAN”)are a well recognized type of data link that is used widely for communicating between electronic devices. Often a CAN data link is used to communicate between a single electronic device on one drop of the CAN and multiple electronic devices on other drops of the CAN.

An inherent feature to CAN data links is that only a single data message may be transmitted on it at one time. When multiple electronic devices attempt to simultaneously transmit on the CAN, the CAN automatically prioritizes the messages, and typically transmits them serially until all of the messages have been transmitted.

The word “transmits” as used herein is generally intended to include the idea of “transmitting a signal on”, but also may include the concept of generating a signal, where appropriate or where indicated by the context.

One drawback to the above technique is that it can consume a relatively large amount of time. This is especially true if you are only interested in one of the data messages. For example, eight pressure sensors may be coupled with a CAN data link to transmit their respective pressure signals to a controller. In a particular application, only the highest pressure signal, or perhaps the lowest pressure signal, for example, of the eight pressure sensors may be needed. Due to the CAN protocol, however, all eight pressure signals would typically be transmitted to the controller, using up otherwise unnecessary bandwidth. Further, there is no easy way to predict when the particular pressure signal that you are interested in will be transmitted. It could be first signal received, or it could just as easily be the eighth signal received from the CAN by the controller. In the latter case, an unnecessary delay would be experienced.

An additional problem with this type of system is that it may use a large amount of processing time by the controller. The burden of filtering out the unneeded signals falls to the controller, which takes time that could otherwise be used for other tasks.

### SUMMARY OF THE INVENTION

The present invention provides apparatuses and methods for transmitting data. A data link transmits a plurality of signals, one signal at a time. A plurality of electronic devices is coupled with the data link, and transmit respective first signals to the data link. The plurality of electronic devices also receive a second signal and attempt to transmit their respective first signal onto the data link as a function of receiving the second signal. A signal generating device is coupled with the data link and transmits a third signal to the plurality of electronic devices via the data link for a predetermined period of time. The transmission of the third signal occurs after the second signal is transmitted to the plurality of electronic devices and prior to the transmission of the plurality of first signals from the plurality of electronic devices in response to the second signal.

### BRIEF DESCRIPTION OF THE DRAWINGS

FIG. 1 is a functional block diagram of an apparatus for transmitting data according to one embodiment of the invention.

FIG. 2 is a functional block diagram of a portion of the CAN I/O circuits according to one embodiment of the invention.

### DETAILED DESCRIPTION

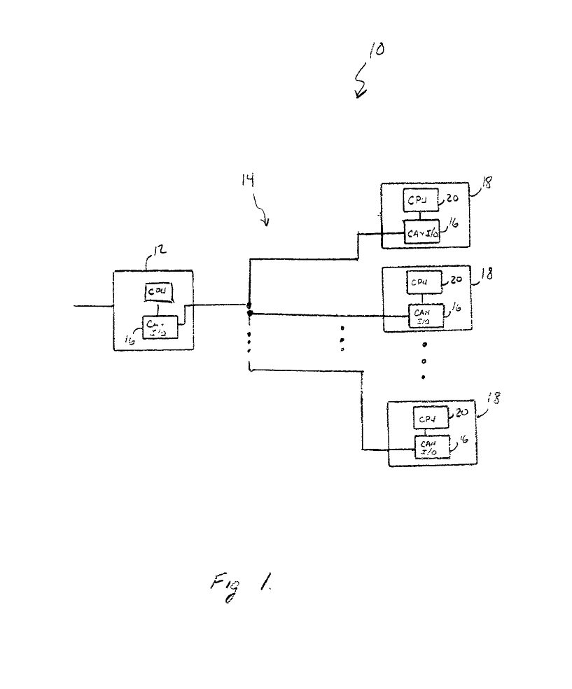

FIG. 1 is a functional block diagram of an apparatus 10 for transmitting data according to one embodiment of the invention. A first electronic device, such as a primary or master controller 12 is coupled with a data link, such as a CAN data link 14, via a CAN input/output (“I/O”) circuit 16. The CAN I/O circuit 16, as well as the other circuits described herein, may be implemented with hardware, software, firmware, or some combination thereof, with software being, in effect, a temporary circuit.

The CAN data link 14 is also typically coupled with a plurality of other electronic devices, such as secondary or slave controllers 18, although it may also be coupled with only a single electronic device. Other types of electronic devices and/or data links known to those skilled in the art may also be used, as appropriate.

Each of the electronic devices typically includes their own CAN I/O circuit 16 and some type of processing unit, such as a central processing unit (“CPU”) 20. The CAN I/O circuits 16 control the receipt and transmission of data signals on the CAN data link 14 as described below.

The CAN data link 14, in conjunction with the CAN I/O circuits 16, contains several inherent features. First, the CAN data link 14 typically only transmits one signal at a time. If the CAN data link 14 is in the process of transmitting a first signal when an electronic device attempts to begin transmission of a second signal on the CAN data link 14, the CAN I/O circuit 16 for the electronic device trying to transmit the second signal will not transmit on the CAN data link 14 until the CAN data link 14 is available, i.e., after the transmission of the first signal is complete.

Second, if two or more electronic devices simultaneously begin to transmit data signals to the CAN data link 14, the CAN I/O circuits 16 arbitrate, or prioritize, the data signals, such as on a bit by bit basis, typically transmitting the data signal having predetermined characteristics, such as having a lowest identifier or the lowest bit value.

For example, each of the electronic devices attempts to transmit the first bit of their data signal. The CAN I/O circuits 16 determine which of the first bits of the data signals is lowest and each electronic device having a first bit equal to that lowest value, such as zero, transmits that bit to the CAN data link 14. For example, if one data signal was “111”, while a second message was “011”, the “011” message would win arbitration for the first bit, and a zero would be transmitted on the CAN data link 14.

The electronic devices having the data signals that lost the arbitration (the data signal having the higher bit value, for example) stop trying to transmit their data signals and wait to transmit again when the CAN data link 14 is free by ways known to those skilled in the art.

The electronic devices having the data signals that won the arbitration arbitrate the second data bit of their data signals and proceed in the same manner as is described above. If only one data signal won the arbitration, the CAN I/O circuit 16 transmitting that signal transmits all of its data bits until it has transmitted its entire data signal. In either case, the data signal having the lowest bit value, for example, will be transmitted first over the CAN data link 14. Two or more data signals may win the arbitration if they are identical.

It will be understood that the CAN protocol and I/O circuits 16 could be modified to arbitrate in other equivalent ways, such as transmitting the data signal having the highest bit value, for example. Appropriate changes may be made to the invention to address these different types of arbitration.

If the CAN data link 14 is not “busy”, e.g., in the process of transmitting a message when an electronic device attempts to transmit its data signal, the first electronic device that begins to transmit on the CAN data link 14 will have its message transmitted in its entirety. Arbitration for that electronic device and data signal would not need to be performed.

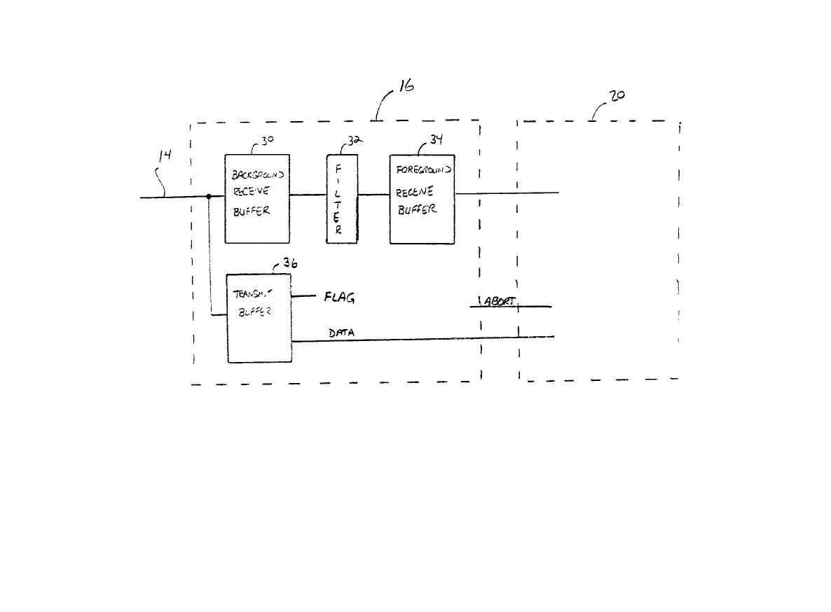

FIG. 2 is a functional block diagram of a portion of the CAN I/O circuits 16 according to one embodiment of the invention. Each of the CAN I/O circuits 16 typically includes a background receive buffer 30 that is coupled with the CAN data link 14 to receive whatever is being transmitted on the CAN data link 14.

A filter 32 is typically coupled with the background receive buffer 30, and functions by ways known to those skilled in the art. The filter 32 may be implemented in either hardware or software, or both, as appropriate. Usually the filter 32 is customized for each electronic device, although it need not be. If the data signal received from the background receive buffer 20 passes through the filter 32 by ways known to those skilled in the art, the data signal may enter a foreground receive buffer 34.

When a data signal is placed in the foreground receive buffer 34, the CPU 20 for that electronic device is notified by ways known to those skilled in the art that a data signal has been received that needs to be acted upon. The CPU 20 then acts on the data signal by ways known to those skilled in the art.

Other configurations known to those skilled in the art for receiving data signals and notifying the CPU 20 that a message has been received may also be used, as appropriate.

Typically a transmit buffer 36 is coupled with the CPU 20 to receive the data signal (“DATA”) that is to be transmitted on the CAN data link 14. The transmit buffer 36 also typically receives a flag signal (“FLAG”) that triggers the transmission of the data signal DATA onto the CAN data link 14. The flag signal FLAG may be transmitted by any of a variety of appropriate ways known to those skilled in the art.

In one embodiment of the invention, a register (not shown) may be coupled with the transmit buffer 36. One or more bits of the register may be used in ways known to those skilled in the art to control the transmission of signals by the transmit buffer 36, e.g., either allowing or preventing the transmission. In this embodiment, the bit or bits that control the transmission may be considered to be the flag signal FLAG.

Typically, the flag signal FLAG is transmitted by the CPU 20 after the entire data signal DATA has been loaded into the transmit buffer 36, although it may also be transmitted in other appropriate situations known to those skilled in the art.

In one embodiment of the invention the background receive buffer 30 is coupled with the transmit buffer 36 to receive the data signal DATA transmitted by the transmit buffer 36.

Referring back to FIG. 1, in one embodiment of the invention, two or more of the CAN I/O circuits 16 may simultaneously, or as close to simultaneously as can be reasonably expected, begin transmission of their respective data signals. This may be accomplished in a variety of ways.

For example, prior to the CAN I/O circuits 16 beginning to transmit their respective data signals DATA, e.g., while the transmit buffers 36 for the CAN I/O circuits 16 are queuing up their respective data signals DATA, a “dummy” message or signal may be transmitted on the CAN data link 14 by any of a variety of signal generating devices, such as by another CAN I/O circuit 16 that is not in the process of queuing up a data signal, for example. The “dummy” message ties up the data link, in effect transmitting a “busy” signal to each of the CAN I/O circuits 16. Because the CAN I/O circuits 16 have not begun to transmit their data signals, they all wait until the CAN data link 14 transmission of the “dummy” message has ended.

In one embodiment of the invention, the duration of the “dummy” message is sufficient to allow each of the CAN I/O circuits 16 time to prepare their respective data signal for transmission on the CAN data link 14, e.g., load the data signal into its respective transmit buffer 36. Thus, this technique may be used to compensate for any variation in queuing up time for the CAN I/O circuits 16. In effect, each of the CAN I/O circuits 16 is synchronized by the dummy message, as each CAN I/O circuit 16 will begin the transmission of their data signal to the CAN data link 14 at substantially the same time: when the transmission of the dummy signal ends, when the CAN data link 14 becomes available to transmit.

In another embodiment of the invention, a timing device (not shown) may be coupled with each transmit buffer 36 to synchronize the transmission of their respective data signals. A single timing device may be used for all CAN I/O circuits 16, or multiple timing devices may also be used, e.g., one timing device per CAN I/O circuit 16 or subset of CAN I/O circuits 16. The synchronization using timing devices may be accomplished using any of a variety of ways known to those skilled in the art.

In another embodiment of the invention, the flag signal FLAG for each transmit buffer 36 may be synchronized so that the transmit buffers 36 that are going to transmit a data signal each receive the flag signal FLAG at substantially the same time. This synchronization may be accomplished using any of a variety of ways known to those skilled in the art, such as having a single circuit (not shown) transmit the flag signal FLAG to each of the appropriate transmit buffers 36.

A variety of other ways known to those skilled in the art may also be used to synchronize the transmission of the data signals DATA by the transmit buffers 36 of the CAN I/O circuits 16.

In one embodiment of the invention, the CAN I/O circuit 16 may also receive an abort signal (“ABORT”). The abort signal ABORT causes the CAN I/O circuit 16 to reset, abort or otherwise cancel the transmission of any data signal that is in the transmit buffer and has lost arbitration or has not yet begun transmission. The CAN I/O circuits 16 typically ignore any abort signal ABORT while transmitting by ways known to those skilled in the art.

Typically the abort signal ABORT is transmitted by the CPU 20 although it may also be transmitted by a variety of other devices known to those skilled in the art. In one embodiment of the invention, the abort signal ABORT is transmitted by the CPU as a function of receiving the “dummy” signal, although it may also be transmitted in response to other stimulus.

The abort signal ABORT may be transmitted to the transmit buffer 36 or to any of a variety of other appropriate circuits known to those skilled in the art. In one embodiment of the invention, a register (not shown) may be coupled with the CAN I/O circuit 16. One or more bits of the register may be used in ways known to those skilled in the art to activate the abort function. In this embodiment, an appropriate bit or bits of the register may be considered to be the abort signal ABORT. The abort signal ABORT may cause the above effects by any of a variety of ways known to those skilled in the art.

In one embodiment of the invention, the abort signal ABORT may be transmitted by the CPU 20 as a function of the CAN I/O circuit 16 receiving the “dummy” message by ways known to those skilled in the art.

In another embodiment of the invention, the flag signal FLAG may serve a similar purpose as the abort signal ABORT. The transmit buffer 36 may be configured by ways known to those skilled in the art to only transmit when flag signal FLAG has a first characteristic, such as being high. Thus, instead of sending the abort signal ABORT to the transmit buffer 36, the flag signal FLAG may be transmitted having a second characteristic, such as being low. This reduces the number of signals being sent to the transmit buffer 36. In this embodiment, the CAN I/O circuit 16 would typically be configured to allow the transmit buffer 36 to load the data signal DATA while the flag signal FLAG is low, for example, and would only reset or abort if the low flag signal FLAG is received after the entire data signal DATA is loaded into the transmit buffer 36.

CAN I/O circuits 16 typically operate using either an 11 or 29 bit identifier for each data signal, plus a data field. The data field typically is 16 bits in length, although other sizes may also be possible.

In one embodiment of the invention the apparatus 10 uses the 29-bit identifier format, but with no data field. Instead, the data signal DATA is included in the 29-bit identifier portion of the data signal DATA.

In operation, according to one embodiment of the invention shown in FIG. 1, the master controller 12 transmits a request for data signal (“REQUEST”) onto the CAN data link 14. Each of the CAN I/O circuits 16 receives the request for data signal REQUEST and begins to process it.

Prior to any of the CAN I/O circuits 16 transmitting onto the CAN data link 14 the data signal DATA in response to the request for data signal REQUEST, the master controller 12 transmits the “dummy” signal onto the CAN data link 14. Typically the “dummy” signal is transmitted immediately following the end of the transmission of the request for data signal REQUEST, although a delay of an appropriately short duration may also be interposed.

While processing the request for data signal REQUEST, the CAN I/O circuits 16 transmit the request for data signal REQUEST to their respective CPU 20. The request for data signal REQUEST typically sets one or more bits in a register (not shown) that activates an interrupt of the CPU by ways known to those skilled in the art. The CPU 20 then processes the request for data signal REQUEST by ways known to those skilled in the art.

The processing of the request for data signal by the CPU 20 results in the data signal DATA being loaded into the transmit buffer 36 of the respective CAN I/O circuit 16. The data signal DATA transmitted by the CPU 20 may be based on a programmed function internal to the CPU 20, or it may be a function of an external input received by the slave controller 18, such as from a sensor or sensing device(not shown).

As stated above, the duration of the “dummy” signal is typically long enough to allow each of the slave controllers 18 sufficient time to load the data signal DATA into their respective transmit buffers 36.

Each of the slave controllers 18 waits until the CAN data link 14 finishes transmitting the “dummy” signal, i.e., becomes available to transmit, and then begins to transmit their respective data signal DATA. Being synchronized by the “dummy” signal, all of the slave controllers 18 begin transmission of their respective data signal DATA onto the CAN data link 14 at substantially the same time.

Each of the CAN I/O circuits 16 for each of the slave controllers 18 that are transmitting data signals DATA begins to arbitrate between the signals, establishing which of the data signals DATA will be transmitted first. The data signal DATA winning arbitration is transmitted in its entirety onto the CAN data link 14.

As mentioned above, the CPU 20 of the slave controller 18 may transmit the abort signal ABORT to the CAN I/O circuit 16 as a function of the CAN I/O circuit 16 receiving the “dummy” message. The processing of the “dummy” message and transmission of the abort signal ABORT takes a predetermined amount of time. This predetermined amount of time is typically longer than it takes for the slave controllers 18 to queue up their respective data signals DATA and begin transmission thereof. Thus the signal that wins arbitration continues to transmit, ignoring the abort signal ABORT as described above.

Any of the slave controllers 18 having a data signal DATA that lost arbitration, and therefore is not transmitting, will act on the abort signal ABORT, and not try to retransmit its data signal DATA. Thus, the data signal DATA that wins the arbitration is transmitted first, and all of the data signals DATA that lose arbitration are not transmitted. The bandwidth that otherwise would have been used by transmitting each of the data signals DATA that lost the initial arbitration is thus available for other tasks.

In another embodiment of the invention the abort signal ABORT may not be used. Thus, each of the data signals DATA from the CAN I/O circuits 16 will be transmitted, although the lowest data signal DATA will still be transmitted first.

Industrial Applicability

The apparatus 10 may be used to decrease the amount of bandwidth needed in transmitting multiple signals when only one signal having a predetermined relationship to the other signals, such as being the lowest value, is desired. For example, several pressure or other types of sensors (not shown) could be coupled with the slave controllers 18. If only the lowest pressure signal from the sensors is desired by the master controller 12, the apparatus 10 would ensure that the lowest signal is the first one transmitted to the master controller 12.

In addition to causing the desired data signal to be the first data signal transmitted on the CAN data link 14 to the master controller 12, the apparatus 10 may also decrease the amount of processing time needed by the master controller 12. In the past, the master controller 12 received a data signal from each slave controller, and then had to determine which data signal it would use. With the apparatus 10, the master controller only receives the data signal that it uses, and the processing time otherwise needed to determine which data signal it needed may be used for other tasks.

If the highest pressure signal were desired instead of the lowest signal, the arbitration scheme described above could be used if the data signal from each of the sensors were inverted. Thus, the highest value data signal would become the lowest, and would be transmitted first onto the CAN data link 14. An appropriate conversion may be needed on the other end, and could be performed by any of a variety of ways known to those skilled in the art. Alternately, a different arbitration scheme could be used that arbitrates in favor of the highest data signal.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus for transmitting data, comprising:
a data link operable to transmit a plurality of signals, one signal at a time;
a plurality of electronic devices coupled with the data link, the plurality of electronic devices operable to transmit respective first signals to the data link, the plurality of electronic devices further operable to receive a second signal and to attempt to transmit the respective first signal onto the data link as a function of receiving the second signal; and
a signal generating device coupled with the data link and operable to transmit a third signal to the plurality of electronic devices via the data link for a predetermined period of time, the transmission of the third signal operable to occur after the second signal is transmitted to the plurality of electronic devices and prior to the transmission of the plurality of first signals from the plurality of electronic devices in response to the second signal.

2. The apparatus of claim 1 wherein the first signal comprises a data signal, the second signal comprises a request for data signal, and the third signal comprises a dummy signal.

3. The apparatus of claim 1 wherein the signal generating device is operable to transmit the second signal to the plurality of electronic devices.

4. The apparatus of claim 1 wherein the signal generating device is operable to transmit the third signal substantially immediately after the transmission of the second signal is transmitted.

5. The apparatus of claim 1 wherein the data link comprises a controller area network data link.

6. The apparatus of claim 1 wherein the signal generating device comprises a primary controller and the plurality of electronic devices comprise secondary controllers.

7. The apparatus of claim 1 further comprising a respective plurality of sensing devices coupled with the respective plurality of electronic devices, the respective sensing devices operable to transmit a respective sensor signal to the respective electronic device, the respective first signals transmitted by the electronic devices being a function of the respective sensor signals.

8. The apparatus of claim 1 wherein the plurality of electronic devices are operable to arbitrate between the plurality of first signals such that the electronic device having the first signal having a first characteristic is operable to transmit first onto the data link.

9. The apparatus of claim 8 wherein the first characteristic comprises having a lowest identifier.

10. The apparatus of claim 8 wherein the plurality of electronic devices that lose arbitration are operable to abort their respective transmissions of the first signal as a function of receiving the third signal.

11. An apparatus for transmitting data, comprising:
a data link operable to receive a plurality of data signals and to transmit one of the plurality of data signals having a predetermined characteristic;
a plurality of electronic devices coupled with data link, the plurality of electronic devices operable to transmit the plurality of data signals to the data link at substantially the same time as a function of an input signal; and
a signal generating device coupled with the plurality of electronic devices, the signal generating device operable to transmit the input signal to the plurality of electronic devices.

12. The apparatus of claim 11 wherein the predetermined characteristic comprises having a lowest identifier.

13. The apparatus of claim 12 wherein the data signal having the lowest identifier comprises the signal having a lowest value.

14. The apparatus of claim 11 wherein the signal generating device is operable to prevent the transmission of the data signals by the plurality of electronic devices on the data link by tying up the data link for a predetermined period of time.

15. The apparatus of claim 11 wherein the input signal comprises a dummy signal and wherein the signal generating device is operable to prevent the transmission of data on the data link by transmitting the dummy signal to the plurality of electronic devices for a predetermined period of time.

16. The apparatus of claim 15 wherein the predetermined period of time comprises a duration of time sufficient to allow all of the electronic devices time to queue up a respective data signal.

17. The apparatus of claim 11 wherein the plurality of electronic devices are operable to transmit the plurality of data signals after the transmission of the input signal is complete.

18. The apparatus of claim 11 wherein the electronic devices are further operable to abort the transmissions of the data signals after one of the data signals is transmitted from one of the electronic devices to the data link.

19. An apparatus for transmitting data, comprising:
a primary controller operable to transmit a request for data signal and to prevent the transmission of data on a data link for a predetermined period of time after the request for data signal is transmitted;
a plurality of secondary controllers coupled with the primary controller to receive the request for data signals, the plurality of secondary controllers operable to substantially simultaneously attempt to transmit a respective plurality of data signals to the primary controller as a function of receiving the request for data signal; and
the data link coupled between the primary controller and the plurality of secondary controllers to receive the respective transmitted signals from one of the primary and the plurality of secondary controllers and operable to transmit the respective signals to the other of the primary and secondary controllers as a function of receiving the respective signals, the data link further operable to arbitrate between the plurality of data signals from the plurality of secondary controllers so that the data signal having a predetermined characteristic is transmitted first on the data link.

20. The apparatus of claim 19 wherein the predetermined characteristic comprises having a lowest identifier.

21. The apparatus of claim 20 wherein the data signal having the lowest identifier comprises the data signal having the lowest value.

22. The apparatus of claim 19 wherein the primary controller is operable to prevent the transmission of data on the data link by tying up the data link for a predetermined period of time.

23. The apparatus of claim 19 wherein the primary controller is operable to prevent the transmission of data on the data link by transmitting a dummy message to the plurality of secondary controllers for the predetermined period of time.

24. The apparatus of claim 19 wherein the predetermined period of time comprises a duration sufficient to allow all of the secondary controllers time to process the request for data signal and queue up a respective data signal in response to the request for data signal.

25. The apparatus of claim 19 wherein the secondary controllers are further operable to abort the transmissions of the data signals after one of the data signals is transmitted from one of the secondary controllers to the primary controller in response to the request for data signal.

26. A method for transmitting data on a CAN data link, comprising:
determining a plurality of data signals in response to at least one input signal; and
synchronizing the transmission of the plurality of data signals so that the plurality of data signals are transmitted to the CAN data link at substantially the same time.

27. The method of claim 26 wherein synchronizing the transmission of the plurality of data signals comprises preventing the transmission of the plurality of data signals for a predetermined period of time.

28. The method of claim 26 wherein synchronizing the transmission of the plurality of data signals comprises tying up the data link for a predetermined period of time.

29. The method of claim 26 wherein synchronizing the transmission of the plurality of data signals comprises transmitting a dummy message on the data link for a predetermined period of time.

30. The method of claim 26 wherein synchronizing the transmission of the plurality of data signals comprises preventing the transmission of the plurality of data signals until a flag signal is received.

31. The method of claim 26, further comprising:
transmitting one of the plurality of data signals on the CAN link; and
aborting the transmission of the others of the plurality of data signals.

32. A method for controlling data transmissions on a data link from a plurality of electronic devices, the plurality of electronic devices operable to transmit a respective plurality of data signals as a function of receiving a request for data, comprising:
transmitting a request for data signal to the plurality of electronic devices;
causing each of the electronic devices to begin transmission of their respective data signals onto the data link at substantially the same time; and
arbitrating between the data signals from the plurality of electronic devices so that the data signal having a predetermined characteristic is transmitted first by the data link.

33. The method of claim 32 wherein the predetermined characteristic comprises being the data signal having a lowest identifier.

34. The method of claim 33 wherein the data signal having the lowest identifier comprises the data signal having a lowest value.

35. The method of claim 32 wherein causing each of the electronic devices to begin transmission of their respective data signals onto the data link at substantially the same time comprises tying up the data link for a predetermined period of time after the transmission of the request for data signal is transmitted.

36. The method of claim 32 wherein causing each of the electronic devices to begin transmission of their respective data signals onto the data link at substantially the same time comprises transmitting a dummy message to the plurality of electronic controllers for a predetermined period of time.

37. The method of claim 36 wherein the predetermined period of time comprises a duration sufficient to allow all of the electronic devices sufficient time to process the request for data and queue up a data signal in response to the request for data signal.

38. The method of claim 32, further comprising:
aborting the data transmissions from the electronic devices after a first data signal is transmitted from one of the electronic devices onto the data link in response to the request for data signal.

39. The method of claim 32, further comprising:
aborting the data transmissions from the electronic devices that lose arbitration at any time prior to the complete transmittal of a first data signal from one of the electronic devices onto the data link in response to the request for data signal.

40. A method for controlling data transmissions on a data link from a plurality of electronic devices, the plurality of electronic devices operable to transmit a respective plurality of data signals as a function of receiving a request for data, comprising:
transmitting a request for data on the data link to the plurality of electronic devices;
preventing the transmission of data from the plurality of electronic devices for a predetermined period of time after receipt by the plurality of electronic devices of the request for data on the data link; and
arbitrating between the responses from the plurality of electronic devices so that the data from one of the plurality of electronic devices having a predetermined characteristic is transmitted first by the data link.

41. The method of claim 40 wherein the predetermined characteristic comprises being the data signal having a lowest identifier.

42. The method of claim 40 wherein the data signal having the lowest identifier comprises the data signal having a lowest value.

43. The method of claim 40 wherein preventing the transmission of data from the electronic devices comprises tying up the data link for the predetermined period of time.

44. The method of claim 40 wherein preventing the transmission of data from the electronic devices comprises transmitting a dummy message to the plurality of electronic devices for the predetermined period of time.

45. The method of claim 44 wherein the predetermined period of time comprises a duration sufficient to allow all of the electronic devices sufficient time to process the request for data and queue up their respective data in response to the request for data.

46. The method of claim 40, further comprising:
aborting the data transmissions from the electronic devices when a first data signal is transmitted from one of the electronic devices onto the data link in response to the request for data.

47. The method of claim 40, further comprising:
aborting the data transmissions from the electronic devices that lose arbitration at any time prior to the complete transmittal of a first data signal from one of the electronic devices onto the data link in response to the request for data signal.
